(19) United States
(12) Patent Application Publication
(10) Pub. No.: US 2006/0200827 A1
(43) Pub. Date: Sep. 7, 2006

(54) Methods and systems providing desktop search capability to software application

(76) Inventors: Jeffrey Alan Joseph Sidlosky, San Jose, CA (US); Creighton W. Chong, Fremont, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/060,859

(22) Filed: Feb. 18, 2005

(51) Int. Cl. G06F 9/46

(52) U.S. Cl. 719/310

(57) ABSTRACT

Methods and apparatuses for adding independent functionality to software applications. For one embodiment of the invention, software providing a desktop search functionality is implemented at the operating system level and allows a target application to access and use the desktop search functionality without modification of the application. For one such embodiment, information communicated between the target application and the operating system, or other applications, is intercepted and evaluated. A determination is then made as to whether or not to implement the desktop search functionality within the target application based upon the intercepted information. Desktop search functionality added to the target application may replace or augment the existing desktop search functionality of the target application, if any. For one embodiment of the invention, a desktop search capability is provided to specific applications to which such capability is deemed beneficial.

### CLAIM OF PRIORITY

This application is related to, and hereby claims the benefit of provisional application number TBD, entitled “Software and Method for Delivering Integrated Search and Information Organization Capability to Computer Applications” which was filed Apr. 6, 2004.

### FIELD

Embodiments of the invention relate generally to the field of software applications and more specifically to providing additional functionality to software applications.

### BACKGROUND

The capability of organizing information has grown along with the ever-increasing availability of information. A typical software application for organizing stored information on a personal computer (e.g., laptop, desktop, etc.), organizes the information as multiple files within each of multiple directories. Typically, a user may have hundreds or even thousands of files organized within scores of directories. Such files may contain text entered from a keyboard, or other types of electronic files including pictures, executable programs, sounds, videos or any type of binary file.

To facilitate locating and accessing this information, desktop search functionality has been developed. Such functionality may be implemented as an independent search application or as part of an application for which search functionality is deemed beneficial. For example, a word processing application may provide search functionality so that stored information may be located and incorporated into a document created using the word processing application.

Disadvantages arise when a particular application does not provide functionality that would benefit the application. For example, some e-mail messaging applications do not provide a search capability within the application itself. For such e-mail messaging applications, when a user wishes to attach a file to an e-mail message, the user must know the location of the file to be attached. That is, typically, when the attach file functionality is initiated, the user is presented with a file dialog box, the user must then navigate through the various drives, directories, sub-directories, and files to locate the desired file. This is time-consuming and often futile if the user is not aware of the particular drive, directory, and file name of the desired file.

Even where the application provides desired functionality, the functionality provided may not be as effective as an independent application providing such functionality. For example, where search capability is provided in a word processing application the search capability provided is often not as effective as an independent search application. Therefore the user of such a word processing application may not be able to take advantage of improvements in search capability.

There are many reasons for this including the development time for more complex applications. That is, an application may take months or years to develop. During this time, particular functionality provided by the application may have become obsolete, or an independent application that provides superior functionality has been developed. It is not practical at that point to revise the application to incorporate the superior functionality. Moreover, the superior functionality is often developed independently of the manufacturer of the application. Such manufacturers are reluctant to incorporate independent functionality (even superior functionality) within their products.

For example, a vast source of available information may be found on internet-related networks (e.g. the World Wide Web (Web)) or other Internet sources and Internet search functionality is available. However, Internet search capability is not provided within many applications that would benefit from such functionality. For example, consider a user of a word processing application or an e-mail messaging application who wishes to search the Web for particular information and incorporate that information into their document or e-mail message. Such a user must initiate an independent Web search functionality, obtain the desired information, through, for example, a copy operation, and incorporate the desired information into their document or e-mail message, through for example, a paste, attach, or append operation. This interaction between the user and the several applications is time-consuming and prone to error.

The disadvantages described above in reference to the implementation of search capability (desktop or Internet) in relation to word processing applications or e-mail messaging applications are equally applicable to a wide variety of applications and functionality. Thus, in general, personal computers provide a number of software applications each of which provide various functionality. Such applications often lack specific functionality that may be beneficial in the context of the application; or provide substandard functionality of a specific type. Due to the fact that applications are produced by various manufacturers, it may not be possible or practical for a manufacturer to incorporate specific functionality (or optimum functionality) within a given application.

### BRIEF DESCRIPTION OF THE DRAWINGS

The invention may be best understood by referring to the following description and accompanying drawings that are used to illustrate embodiments of the invention. In the drawings:

FIG. 1 illustrates a process in which a determination is made to provide functionality to an application in accordance with one embodiment of the invention;

FIG. 2 illustrates a block diagram of software interaction in accordance with one embodiment of the invention;

FIG. 3 illustrates a process in which a profile corresponding to search functionality is determined in accordance with one embodiment of the invention;

FIG. 4 illustrates the characteristics of a typical dialog box provided by a word processing application for inserting information in a word processing document in accordance with one embodiment of the invention;

FIG. 5 illustrates a process by which search functionality is implemented within an application in accordance with one embodiment of the invention; and

FIG. 6 is a block diagram illustrating a DPS in accordance with various embodiments of the invention.

### DETAILED DESCRIPTION

Overview

Embodiments of the invention provide the methods and apparatuses for adding functionality to applications without modifying the applications. For one embodiment of the invention, software providing a specific functionality is implemented at the operating system level and allows a target application to access and use the functionality without modification of the application. For one such embodiment, additional functionality software (AFS) intercepts information communicated between the application and the operating system (or other applications), and based upon this intercepted information, provides specific functionality to the application. The functionality provided may replace or augment the existing functionality of the target application.

For one embodiment of the invention, a search capability is provided to specific applications to which such capability is deemed beneficial (e.g., word processing applications and e-mail messaging applications). For one such embodiment, the search capability includes desktop search capability as well as Internet search capability.

In the following description, numerous specific details are set forth. However, it is understood that embodiments of the invention may be practiced without these specific details. In other instances, well-known circuits, structures and techniques have not been shown in detail in order not to obscure the understanding of this description.

Reference throughout the specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

Moreover, inventive aspects lie in less than all features of a single disclosed embodiment. Thus, the claims following the Detailed Description are hereby expressly incorporated into this Detailed Description, with each claim standing on its own as a separate embodiment of this invention.

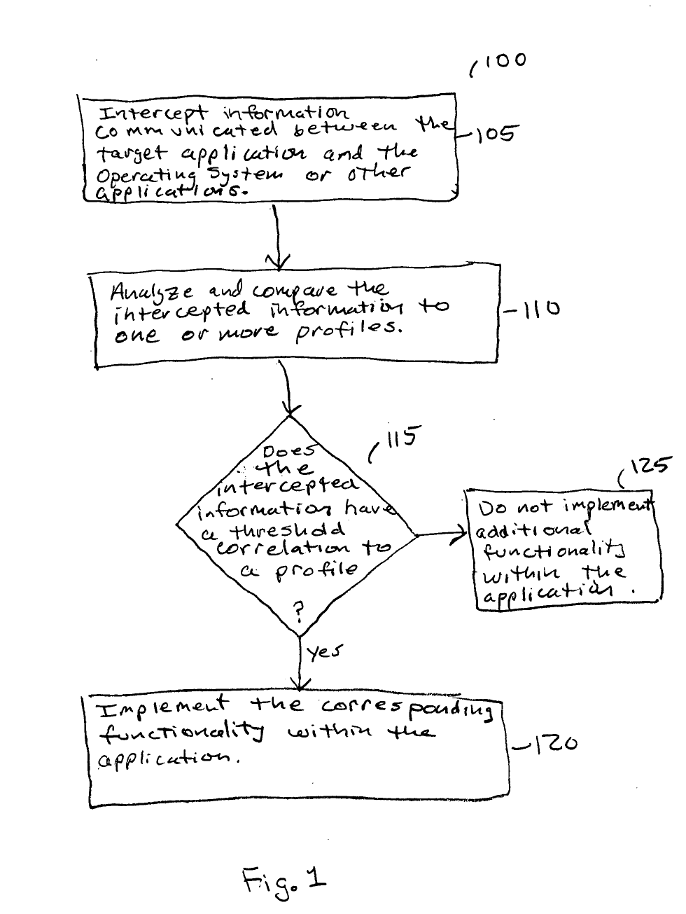

This overview represents some inventive features of various embodiments, which may contain any one of these features alone or in combination. This overview is provided to facilitate the understanding of specific embodiments of the invention discussed below in reference to FIGS. 1-6. This overview does not summarize the invention, nor is it intended to be a summary.

Process

FIG. 1 illustrates a process in which a determination is made to provide functionality to an application in accordance with one embodiment of the invention.

Process 100, shown in FIG. 1, begins with operation 105 in which information communicated between the target application and the operating system (OS) or other applications is intercepted by the AFS.

At operation 110, the AFS analyzes the intercepted information and compares the intercepted information to one or more profiles. Each profile corresponds to specific functionality that is deemed beneficial to particular applications.

At operation 115 if the intercepted information has a threshold correlation to a profile, then the corresponding functionality is implemented within the target application at operation 120.

If, at operation 115, the intercepted information does not have a threshold correlation to a profile, then a determination is made not to implemented additional functionality within the target application at operation 125.

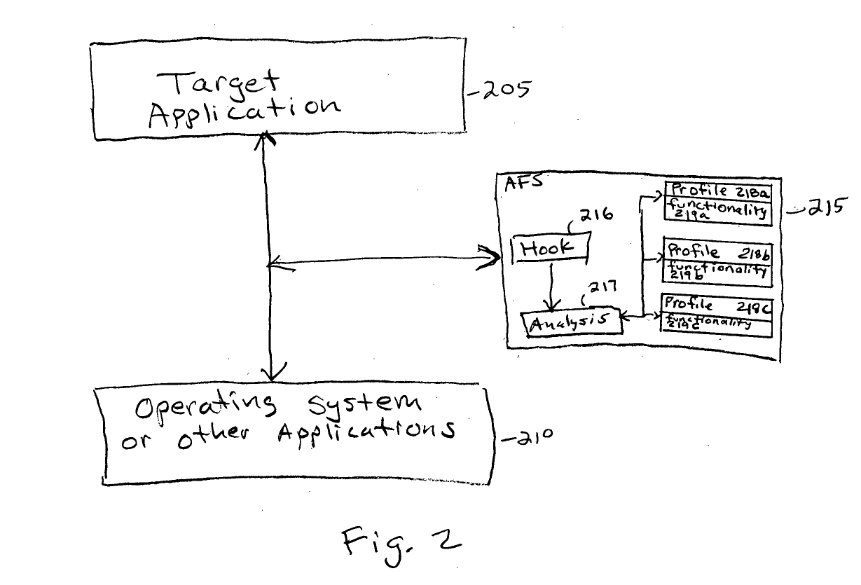

FIG. 2 illustrates a block diagram of a software system in accordance with one embodiment of the invention. System 200, shown in FIG. 2, may be implemented on any convention digital processing system (DPS), and includes a target application 205, an OS (or other applications) 210 and an AFS 215.

As shown in FIG. 2, information is communicated between the target application 205 and the OS or other applications 210. The AFS 215 uses a hook 216 to intercept the information communicated between the target application 205 and the OS or other applications 210. The AFS 215 includes an analysis functionality 217 to compare the intercepted information to one or more profiles, shown for example as profiles 218a-218c. Each profile has corresponding functionality, shown for example as functionalities 219a-219c.

The analysis functionality 217 compares the intercepted information to one or more of the profiles 218a-218c. Upon a determination that the intercepted information has a threshold correlation to a profile, the AFS 215 implements the functionality corresponding to that profile within the target application 205. For example, if upon analysis of the intercepted information, a determination is made that the intercepted information has a threshold correlation with profile 218b, then, the AFS 215 will implement the corresponding functionality (i.e., functionality 219b) within the target application 205.

For one embodiment of the invention, the profiles are disjoint such that intercepted information having a threshold correlation to one profile would not have a correlation to any of the other profiles. In an alternative embodiment of the invention the profiles are not disjoint. For such an embodiment, functionality corresponding to each profile for which the intercepted information has a threshold correlation is implemented within the target application.

### EXEMPLARY EMBODIMENT

Embodiments of the invention are applicable to a wide range of applications and functionality. For purposes of illustration an exemplary embodiment of the invention implementing a search capability within an application is described in greater detail below.

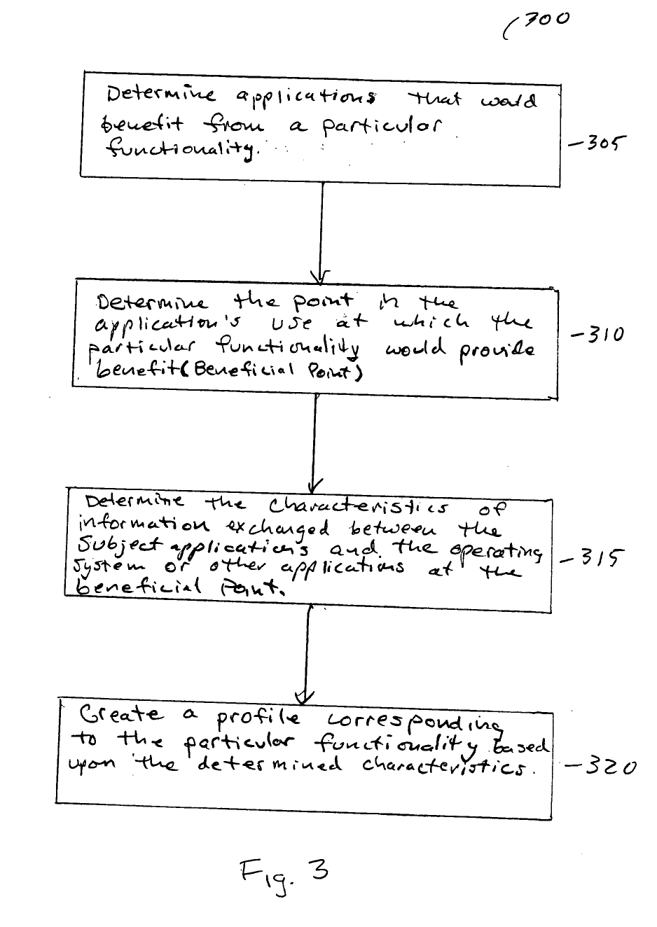

FIG. 3 illustrates a process in which a profile corresponding to search functionality is determined in accordance with one embodiment of the invention. Process 300, shown in FIG. 3, begins at operation 305 in which a determination is made as to which applications will benefit from the particular functionality (subject applications). Search capability, for example, will benefit word processing applications and e-mail messaging applications among others.

At operation 310, the point in the application's use at which the particular functionality will provide the prospective benefit is determined. For example, search capability will allow the user to quickly locate information to be inserted into a word processing document or attached to an e-mail message. Therefore, the point in the application's use at which search capability would be beneficial (beneficial point) is when the user is inserting or attaching information.

At operation 315, the characteristics of the information communicated between the subject applications and the OS or other applications, at the beneficial point is determined. For example, word processing applications that allow a user to insert information typically provide a dialog box having a set of basic buttons (clickable command shortcuts) which may include “OK”, “cancel”, “insert”, and “submit”. The dialog box also typically includes a directory list and an edit box labeled “file name” with a cursor and an edit box labeled “file type”. E-mail messaging applications typically have similar a similar set of buttons, which may include an “attach”, as well as similar features. Another characteristic of such dialog boxes is that they are typically of dimensions of approximately 100 pixels wide or greater.

Characteristics of the communicated information that may be considered relevant may also include items (e.g., buttons, icons, dimensions, etc) that typically would not be included in a dialog box of a word processing application of e-mail messaging application. For example, the characteristic of having more than seven buttons may be considered relevant.

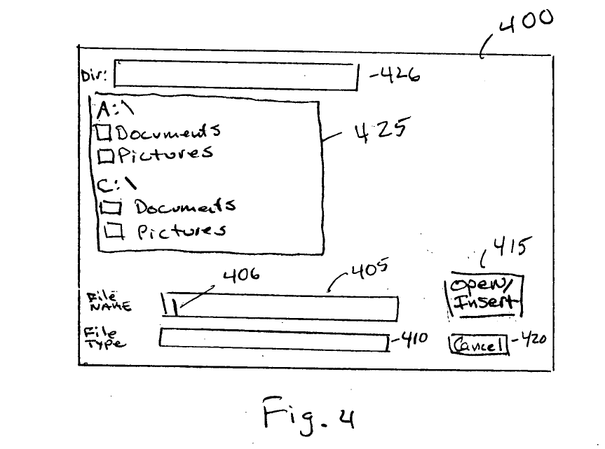

FIG. 4 illustrates the characteristics of a typical dialog box provided by a word processing application for inserting information in a word processing document in accordance with one embodiment of the invention. Dialog box 400, shown in FIG. 4, includes a file name edit box 405 having a cursor 406, a file type edit box 410, an open (insert) button 415, a cancel button 420, and a directory list 425 having an associated directory edit box 426. Dialog box 400 has dimensions, typically greater than 100 pixels square.

Referring again to FIG. 3, at operation 320, a profile corresponding to the functionality is created based upon the determined characteristics. The profile may deem some characteristics more relevant than others and may deem some characteristics (e.g., a file name icon and an edit box) critical, while others may serve to enhance the reliability of the profile.

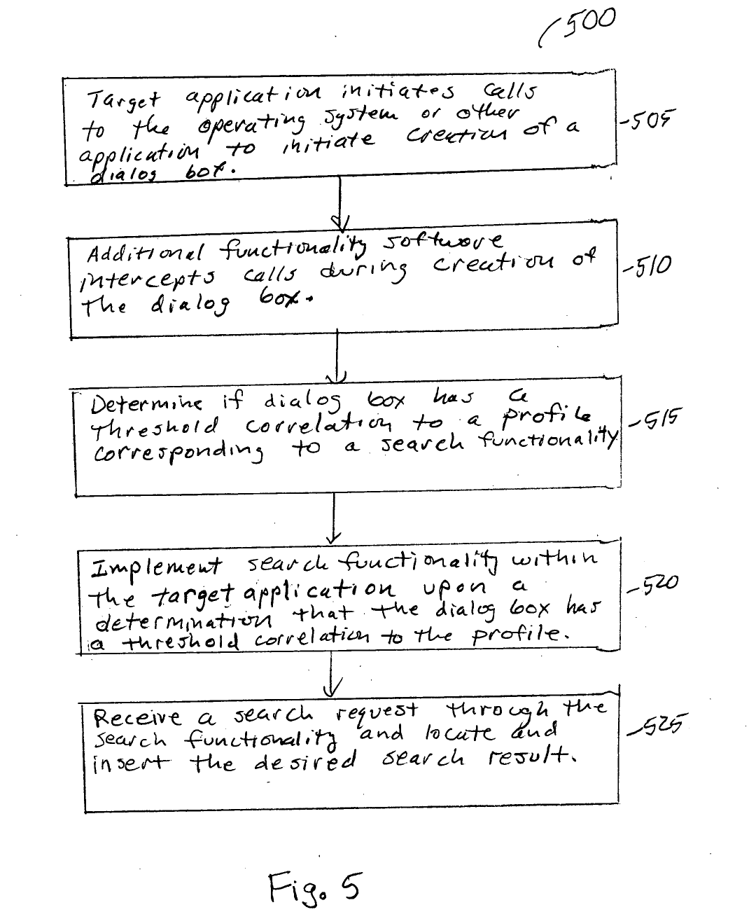

FIG. 5 illustrates a process by which search functionality is implemented within an application in accordance with one embodiment of the invention. Process 500, shown in FIG. 5, begins at operation 505 in which the target application communicates a series of calls to the operating system to initiate the creation of a dialog box.

At operation 510, as the dialog box is being created, the calls to the OS which create the dialog box are intercepted by the AFS. That is, as each component of the dialog box (e.g., insert button, OK button, attach button, etc.) is created, the AFS is monitoring the dialog box creation process.

At operation 515, if the dialog box under construction is determined to have a threshold correlation with the search functionality profile (e.g., as created through process 400, described above in reference to FIG. 4), then the target application is determined to be an application that would benefit from search functionality and search functionality is implemented within the target application. Because the creation of the dialog box is monitored in-progress, a determination to implement search functionality within the target application may be obtained prior to completion of the dialog box.

For one embodiment of the invention a mechanism is provided to avoid falsely determining that an application would benefit from search functionality and, thus, avoid implementing search functionality in an application in which it would not provide a benefit. For one such embodiment, the profile may contain characteristics which if present indicate that search functionality should not be implemented within the target application. Such characteristics may only become evident upon completion of the dialog box. For one embodiment of the invention, therefore, the determination to implement search functionality within the target application is not made until the dialog box creation process is complete.

At operation 520, search functionality is implemented within the target application. The user is provided with a search application that is independent of the target application and without modification to the target application. For example a search functionality interface may appear within the dialog box. In alternative embodiments, the AFS displays its features by manipulating the original application or through interaction with other methods.

At operation 525 a search request is received from a user and the desired search result is incorporated into the product of the target application. For example, the desired search result may be inserted into a word processing document or attached to an e-mail message. For one embodiment of the invention, the AFS automatically accesses the target application and effects incorporation of the desired search result. For example, the AFS automatically presses the insert button or attach button of the dialog box provided by the target application.

Thus embodiments of the invention allow highly effective search functionality to be implemented in applications that do not provide search functionality or provide less effective search capability. For example, typically, search capability provided by word processor applications searches every file on the personal computer for the search term resulting in a significant time to complete the search. In contrast, independent search applications may employ a search index together with specialized search paths and algorithms resulting in a significantly reduced search time.

General Matters

Embodiments of the invention provide methods and apparatuses for adding functionality to applications without modifying the applications. Embodiments of the invention allow a user of any application that may benefit from a search capability to locate and use information on their personal computer or on the Web through use of an independent search application. Although described for various embodiments in the context of adding search capability to a word processing application or e-mail messaging application, it will be apparent to those skilled in the art that embodiments of the invention are applicable to a wide range of software applications and functionality.

The invention includes various operations. Many of the methods are described in their most basic form, but operations can be added to or deleted from any of the methods without departing from the basic scope of the invention. For example, embodiments of the invention have been described above, in reference to FIG. 1, in which, subsequent to a comparison of intercepted information and a profile in which the intercepted information has a threshold correlation with the profile, functionality is added to the target application. In an alternative embodiment of the invention, the comparison operation is aborted upon attaining the threshold correlation and the functionality is implemented within the target application. Such an embodiment reduces the time between intercepting the information and implementing the functionality within the target application.

In accordance with various alternative embodiments of the invention, some of the operations of the invention may be embodied in machine-executable instructions. Alternatively, the operations may be performed by a combination of hardware and software. Aspects of the invention may be provided as a computer program product that may include a machine-readable medium having stored thereon instructions, which may be used to program a computer (or other electronic devices) to perform a process according to the invention as described above.

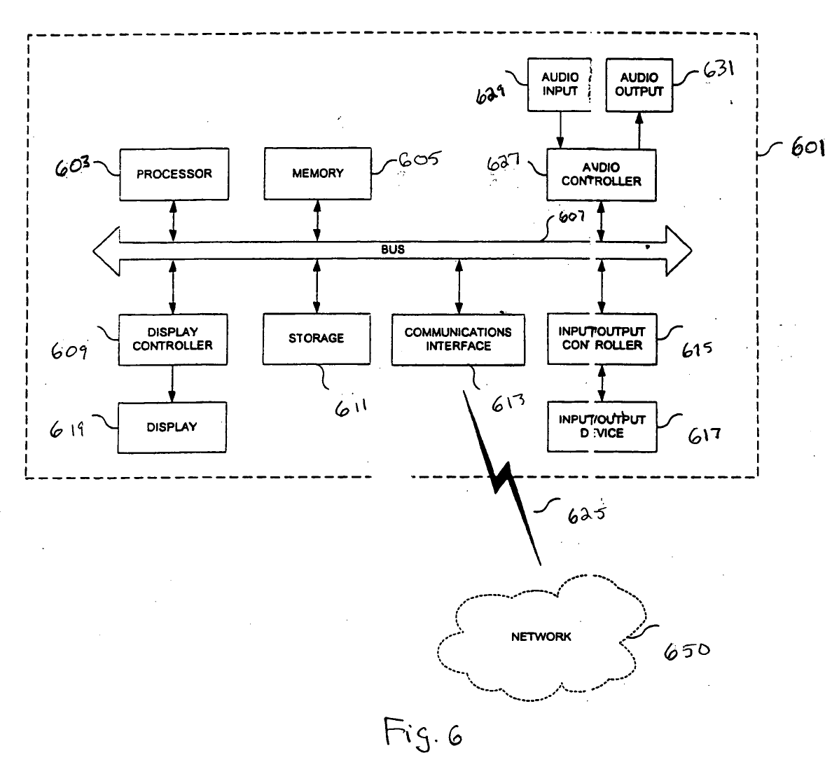

As described above in reference to FIG. 2, embodiments of the invention may be implemented on a DPS. FIG. 6 is a block diagram illustrating a DPS in accordance with various embodiments of the invention. For alternative embodiments of the present invention, DPS 601, shown in FIG. 6, may be a computer that includes a processor 603 coupled to a bus 607. In one embodiment, memory 605, storage 611, display controller 609, communications interface 613, input/output controller 615 and audio controller 627 are also coupled to bus 607.

DPS 601 interfaces to external systems through communications interface 613. Communications interface 613 may include a radio transceiver compatible with wireless telephone signals or other interfaces for coupling a device to other devices. In one embodiment of the present invention, carrier wave signal 625 is received/transmitted between communications interface 613 and network 650. In one embodiment of the present invention, a carrier wave signal 625 may be used to interface DPS 601 with another computer system, a network hub, router or the like. In one embodiment of the present invention, carrier wave signal 625 is considered to be machine readable media, which may be transmitted through wires, cables, optical fibers or through the atmosphere, or the like.

In one embodiment of the present invention, processor 603 may be a conventional microprocessor, such as for example but not limited to an Intel x86 or Pentium family microprocessor, a Motorola family microprocessor, or the like. Memory 605 may be a machine-readable medium such as dynamic random access memory (DRAM) and may include static random access memory (SRAM). Display controller 609 controls in a conventional manner a display 619, which in one embodiment of the invention may be a cathode ray tube (CRT), a liquid crystal display (LCD), an active matrix display, a television monitor or the like. The input/output device 617 coupled to input/output controller 615 may be a keyboard, disk drive, printer, scanner and other input and output devices (e.g., a mouse). In one embodiment of the present invention, audio controller 627 controls in a conventional manner audio output 631 and audio input 629.

Storage 611 may include machine-readable media such as for example but not limited to a magnetic hard disk, a floppy disk, an optical disk, a smart card or another form of storage for data. In one embodiment of the present invention, storage 611 may include removable media, read-only media, readable/writable media or the like. Some of the data may be written by a direct memory access process into memory 605 during execution of software in computer system 601. It is appreciated that software may reside in storage 611, memory 605 or may be transmitted or received via modem or communications interface 613. For the purposes of the specification, the term “machine readable medium” shall be taken to include any medium that is capable of storing data, information or encoding a sequence of instructions for execution by processor 603 to cause processor 603 to perform the methodologies of the present invention. The term “machine readable medium” shall be taken to include, but is not limited to solid-state memories, optical and magnetic disks, carrier wave signals, and the like.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

1-21. (canceled)

22. A method comprising:
creating a profile for a specific functionality, the profile indicating applications that would benefit from the specific functionality;
intercepting calls between a target application and another application, the calls to create a dialog box having specified characteristics;
determining if the specified characteristics have a threshold correlation with the profile; and
implementing the specific functionality within the target application if the specified characteristics have a threshold correlation with the profile.

23. The method of claim 22 wherein the specific functionality is desktop search functionality.

24. The method of claim 22 wherein the other application is an operating system.

25. The method of claim 23 wherein the applications that would benefit from the desktop search capability include word-processing applications and e-mail messaging applications.

26. The method of claim 22 wherein creating the profile for the specific functionality includes:
determining subject applications that would benefit from the specific functionality;
determining the beneficial point of the subject applications;
determining the characteristics of information exchanged between the subject applications and another application at the beneficial point; and
creating a profile based upon the determined characteristics.

27. The method of claim 26 wherein the specified characteristics of the dialog box include characteristics selected from the group consisting of specific buttons, a directory list, a file name edit box having a cursor, a file type edit box, and a dimension greater than 100 pixels square.

28. The method of claim 27 wherein the specific buttons include buttons selected from the group consisting of an OK button, a cancel button, an insert button, an attach button, and a submit button.

29. The method of claim 23 wherein the desktop search functionality employs a search index, specialized search paths, and specialized algorithms for reducing search time.

30. A machine-readable medium containing executable instructions which when executed by a digital process system cause the system to perform a method comprising:
intercepting calls between a target application and another application, the calls to create a dialog box having specified characteristics;
determining if the specified characteristics have a threshold correlation with a profile for a specific functionality, the profile indicating applications that would benefit from the specific functionality; and
implementing the specific functionality within the target application if the specified characteristics have a threshold correlation with the profile such that the target application is not modified.

31. The machine readable medium of claim 30 wherein the specific functionality is desktop search functionality.

32. The machine-readable medium of claim 30 wherein the other application is an operating system.

33. The machine-readable medium of claim 31 wherein the applications that would benefit from the desktop search capability include word-processing applications and e-mail messaging applications.

34. The machine-readable medium of claim 30 wherein the profile for the specific functionality is created through a process comprising:
determining subject applications that would benefit from the specific functionality;
determining the beneficial point of the subject applications;
determining the characteristics of information exchanged between the subject applications and another application at the beneficial point; and
creating a profile based upon the determined characteristics.

35. The machine-readable medium of claim 34 wherein the specified characteristics of the dialog box include characteristics selected from the group consisting of specific buttons, a directory list, a file name edit box having a cursor, a file type edit box, and a dimension greater than 100 pixels square.

36. The machine-readable medium of claim 35 wherein the specific buttons include buttons selected from the group consisting of an OK button, a cancel button, an insert button, an attach button, and a submit button.

37. The machine-readable medium of claim 36 wherein the desktop search functionality employs a search index, specialized search paths, and specialized algorithms for reducing search time.

38. A system comprising:
a target application, the target application communicating calls to a second application, the calls to create a dialog box having specified characteristics; and
an additional functionality software to intercept calls between the target application and the second application, determine if the specified characteristics have a threshold correlation with a profile corresponding to a specified functionality, the profile indicating applications that would benefit from the specified functionality, and implement the specified functionality within the target application upon a determination that the specified characteristics have a threshold correlation with a profile corresponding to the specified functionality.

39. The system of claim 38 wherein the specific functionality is desktop search functionality.

40. The system of claim 38 wherein the second application is an operating system.

41. The system of claim 39 wherein the applications that would benefit from the desktop search capability include word-processing applications and e-mail messaging applications.

42. The system of claim 38 wherein the profile for the specific functionality is created through a process comprising:
determining subject applications that would benefit from the specific functionality;
determining the beneficial point of the subject applications;
determining the characteristics of information exchanged between the subject applications and another application at the beneficial point; and
creating a profile based upon the determined characteristics.

43. The system of claim 42 wherein the specified characteristics of the dialog box include characteristics selected from the group consisting of specific buttons, a directory list, a file name edit box having a cursor, a file type edit box, and a dimension greater than 100 pixels square.

44. The system of claim 43 wherein the specific buttons include buttons selected from the group consisting of an OK button, a cancel button, an insert button, an attach button, and a submit button.

45. The system of claim 39 wherein the desktop search functionality employs a search index, specialized search paths, and specialized algorithms for reducing search time.
